(19) United States
(12) Patent Application Publication
(10) Pub. No.: US 2011/0187314 A1
(43) Pub. Date: Aug. 4, 2011

(54) APPARATUS AND METHOD FOR REDUCING TIME TO CHARGE BATTERY IN PORTABLE DEVICE

(75) Inventor: Tae-Sik KIM, Suwon-si (KR)

(73) Assignee: SAMSUNG ELECTRONICS CO. LTD., Suwon-si (KR)

(21) Appl. No.: 13/017,424

(22) Filed: Jan. 31, 2011

(30) Foreign Application Priority Data
Feb. 3, 2010 (KR) 10-2010-0009868

(51) Int. Cl. H02J 7/04; H02J 7/00

(52) U.S. Cl. 320/107; 320/162

(57) ABSTRACT

A portable apparatus and a method for receiving power through a rechargeable battery to reduce a period of time for battery charge are provided. The apparatus includes a charge circuit for supplying current to the rechargeable battery to charge the rechargeable battery, a comparator for comparing a voltage of the rechargeable battery with a threshold voltage, and a controller for changing from a sleep mode to a suspend mode according to a comparison result of the comparator, for monitoring the current flowing into the rechargeable battery at the charge circuit in the suspend mode, and for determining whether the charge of the rechargeable battery is completed according to the current flowing into the rechargeable battery.

### PRIORITY

This application claims the benefit under 35 U.S.C. §119(a) of a Korean patent application filed in the Korean Intellectual Property Office on Feb. 3, 2010 and assigned Serial No. 10-2010-0009868, the entire disclosure of which is hereby incorporated by reference.

### BACKGROUND OF THE INVENTION

1. Field of the Invention

The present invention relates to a portable device. More particularly, the present invention relates to an apparatus and a method for reducing an amount of time taken to charge a rechargeable battery in a portable device including a charge circuit therein.

2. Description of the Related Art

Portable devices such as portable phones, requiring portability are supplied with power from a battery. In general, a rechargeable battery may be used. Before the battery is completely discharged, a user needs to recharge the battery within a certain period of time. For doing so, a charge circuit for supplying current to recharge the battery is equipped inside or outside the portable device. When the charge circuit is embedded in the portable device, a battery charger does not include the charge circuit. The charger without the charge circuit is referred to as a Travel Adaptor (TA).

The portable device including the charge circuit monitors TA current to recognize the open of a battery port and the charge completion. Herein, the TA current indicates electric current flowing into the battery. For example, when the TA current is 190 mA, charge completion is recognized. When the TA current is less than 60 mA, port open is recognized. The open of a battery port is determined based on 60 mA because only the current as much as the consumed current of the portable device flows as the TA current. Accordingly, when the consumed current of the portable device during the charge is less than 60 mA, reference current of the port open decreases.

To monitor the TA current, the portable device operates in a suspend mode during the charge. In the suspend mode, some current is consumed for the operation of the portable device; that is, the operation of an internal processor. The current for operating the portable device is in competition with the current for charging the battery. Hence, part of the current for charging the battery for the suspend mode operation is consumed. As a result, a period of time required to recharge the battery is extended.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for reducing a period of time for battery charge in a portable device.

Another aspect of the present invention is to provide an apparatus and a method for determining whether to monitor a TA current according to a magnitude of voltage applied to a battery in a portable device.

In accordance with an aspect of the present invention, a portable apparatus for receiving power through a rechargeable battery is provided. The apparatus includes a charge circuit for supplying current to the battery to charge the battery, a comparator for comparing a voltage of the battery with a threshold voltage, and a controller for changing from a sleep mode to a suspend mode according to a comparison result of the comparator, for monitoring current flowing into the battery at the charge circuit in the suspend mode, and for determining whether the charge of the battery is completed according to the current flowing into the battery.

In accordance with another aspect of the present invention, an operating method of a portable device for receiving power through a rechargeable battery is provided. The method includes supplying current to the battery to charge the battery, comparing a voltage of the battery with a threshold voltage, changing from a sleep mode to a suspend mode according to a comparison result, and monitoring current flowing into the battery at a charge circuit in the suspend mode, and determining whether the charge of the battery is completed according to the current flowing into the battery.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of a portable device according to an exemplary embodiment of the present invention; and

FIG. 2 is a flowchart for charging a battery of a portable device according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for purposes of illustration only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide a technique for reducing a period of time for battery charge in a portable device including a charge circuit. Hereinafter, the portable device embraces all of devices which use a rechargeable battery, such as a cellular phone, a Personal Communication System (PCS), a Personal Digital Assistant (PDA), an International Mobile Telecommunication (IMT)-2000 terminal, a laptop computer, and the like.

Technical basis of the present invention is explained in brief.

A shortcoming of the conventional technique is caused by current consumption when a Travel Adaptor (TA) current is monitored continuously. In this regard, an exemplary embodiment of the present invention monitors the TA current only in a certain condition. That is, the portable device monitors the TA current only when a battery voltage exceeds a threshold. Advantageously, the threshold is less than the battery voltage when the charge is completed. For example, the threshold can be 4.1V. When the battery voltage falls below 4.1V, the portable device recharges in a sleep mode. When the battery voltage exceeds 4.1V, the portable device recharges in a suspend mode.

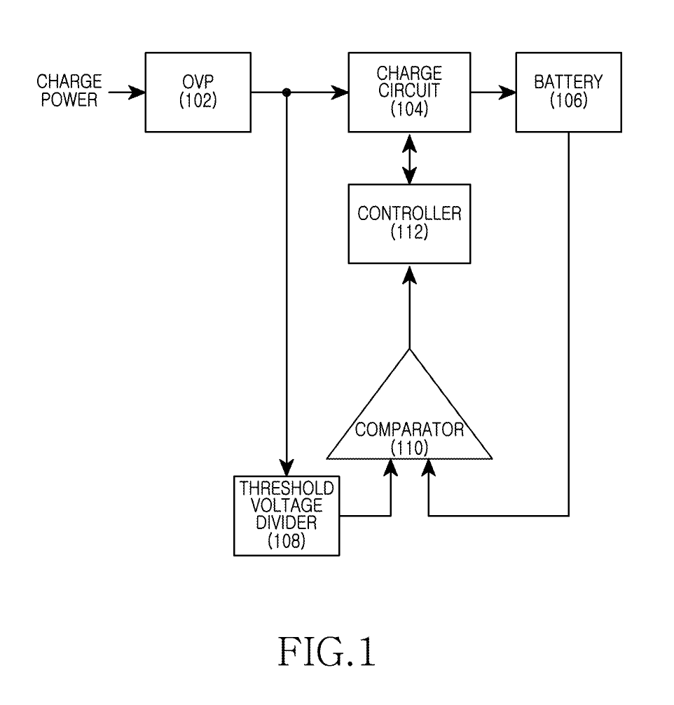

FIG. 1 is a block diagram of a portable device according to an exemplary embodiment of the present invention.

Referring to FIG. 1, the portable device includes an Over Voltage Protector (OVP) 102, a charge circuit 104, a battery 106, a threshold voltage divider 108, a comparator 110, and a controller 112.

The OVP 102 protects the charge circuit 104 against an excessive external charge power. That is, when voltage over a certain magnitude is applied from the outside, the OVP 102 blocks current flowing from the external power source to the charge circuit 104. When the voltage below the certain magnitude is applied from the outside, the OVP 102 supplies the current to the charge circuit 104.

The charge circuit 104 determines whether it is connected to the external charge power. If it is determined that the external charge power is connected, the charge circuit 104 supplies the current to the battery 106 to charge the battery 106 using the external charge power under the control of the controller 112. While charging the battery 106, the charge circuit 104 notifies the TA current value to the controller 112. The battery 106 supplies the power to operate the portable device, and is recharged by the current supplied from the charge circuit 104.

The threshold voltage divider 108 provides a threshold voltage to the comparator 110. That is, the threshold voltage divider 108 generates the threshold voltage by dividing the threshold voltage from the voltage applied to the charge circuit 104 using a resistance. For example, the threshold voltage can be 4.1V. Alternatively, the threshold voltage divider 108 can generate the threshold voltage using a separate power source, rather than generating the threshold voltage using the voltage applied to the charge circuit 104.

The comparator 110 receives the voltages from the battery 106 and the threshold voltage divider 108, and compares the voltage from the battery 106 with the voltage from the threshold voltage divider 108. According to the comparison result, when the voltage from the battery 106 is greater than or equal to the voltage from the threshold voltage divider 108, the comparator 110 notifies this to the controller 112. That is, when the voltage from the battery 106 is greater than or equal to the voltage from the threshold voltage divider 108, the comparator 110 gives the interrupt to change the controller 112 from the sleep mode to the suspend mode.

The controller 112, which is an application processor, controls the charge circuit 104 to supply the current to charge the battery 106. More specifically, the controller 112 operates in the sleep mode when the initial charge begins. In other words, when the initial charge begins, the controller 112 does not consume the current by not monitoring the TA current. When the comparator 110 notifies that the voltage of the battery 106 is greater than or equal to the threshold voltage, the controller 112 exits the sleep mode and operates in the suspend mode. That is, the controller 112 monitors the TA current and determines whether the charge of the battery 106 is completed. If it is determined that the charge of the battery 106 is completed, the controller 112 controls the charge circuit 104 to stop the charge current supply to the battery 106.

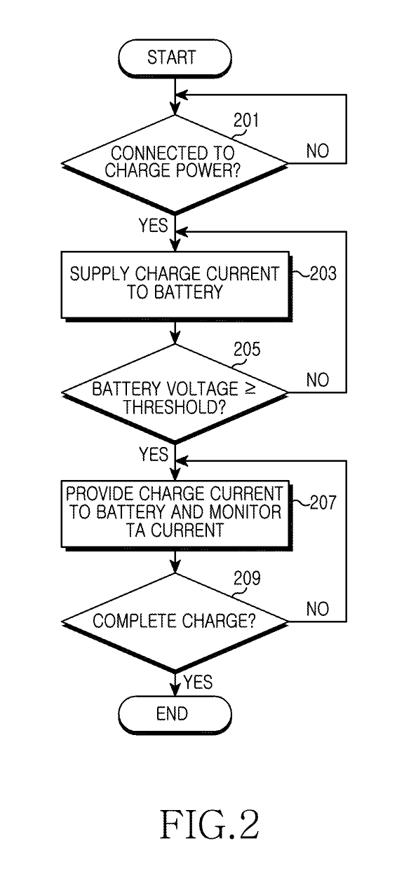

FIG. 2 is a flowchart for charging a battery of a portable device according to an exemplary embodiment of the present invention.

Referring to FIG. 2, the portable device determines in step 201 whether the charge power is connected. The charge power is supplied from the external charger. Whether the charge power is connected, that is, whether the charger is connected is determined by the charge circuit of the portable device.

If it is determined in step 201 that the charge power is connected, the portable device supplies the charge current to the battery in step 203. The charge current is generated by the charge circuit. In so doing, the portable device operates in the sleep mode.

While supplying the charge current, the portable device determines whether the voltage of the battery exceeds the threshold in step 205. The threshold is the reference value of the voltage for determining the charge degree of the battery. It is preferable that the threshold is smaller than the voltage of the completely charged battery. The threshold voltage indicating the threshold is generated by dividing the threshold voltage from the voltage applied to the charge circuit using at least one resistor. For example, the threshold can be 4.1V.

If it is determined in step 205 that the battery voltage is less than the threshold, the portable device returns to step 203.

In contrast, if it is determined in step 205 that the battery voltage is greater than or equal to the threshold, the portable device supplies the charge current to the battery and concurrently monitors the TA current in step 207. Herein, the TA current indicates the current flowing into the battery.

During supplying of the charge current, the portable device determines whether the charge of the battery is completed in step 209. Whether the charge of the battery is completed is determined using the TA current. That is, when the difference between the TA current and the current consumed to operate the portable device falls below the threshold, the portable device determines that the charge is completed.

Since the portable device including the charge circuit inside monitors the TA current only when the battery voltage exceeds the threshold, more current for charging the battery can be obtained. Therefore, a period of time taken to recharge the battery is reduced.

While the invention has been described with reference to certain exemplary embodiments thereof, it will be understood by those skilled in the art that various changes in form and details may be made therein without departing from the spirit and scope of the invention as defined by the appended claims and their equivalents.

What is claimed is:

1. A portable apparatus for receiving power through a rechargeable battery, the apparatus comprising:
a charge circuit for supplying current to the rechargeable battery to charge the rechargeable battery;
a comparator for comparing a voltage of the rechargeable battery with a threshold voltage; and
a controller for changing from a sleep mode to a suspend mode according to a comparison result of the comparator, for monitoring the current flowing into the rechargeable battery at the charge circuit in the suspend mode, and for determining whether the charge of the rechargeable battery is completed according to the current flowing into the rechargeable battery.

2. The apparatus of claim 1, further comprising:
a threshold voltage divider for generating the threshold voltage and providing the threshold voltage to the comparator.

3. The apparatus of claim 2, wherein the threshold voltage divider generates the threshold voltage by dividing the threshold voltage from a voltage applied to the charge circuit using at least a single resistor.

4. The apparatus of claim 1, wherein, when the voltage of the rechargeable battery is greater than or equal to the threshold voltage, the controller monitors the current flowing into the rechargeable battery.

5. The apparatus of claim 4, wherein, when the voltage of the rechargeable battery is greater than or equal to the threshold voltage, the comparator gives an interrupt to the controller and changes the controller from the sleep mode to the suspend mode.

6. An operating method of a portable device for receiving power through a rechargeable battery, the method comprising:
supplying current to the rechargeable battery to charge the rechargeable battery;
comparing a voltage of the rechargeable battery with a threshold voltage;
changing from a sleep mode to a suspend mode according to a comparison result between the voltage of the rechargeable battery and the threshold voltage;
monitoring current flowing into the rechargeable battery at a charge circuit in the suspend mode; and
determining whether the charge of the rechargeable battery is completed according to the current flowing into the rechargeable battery.

7. The method of claim 6, further comprising:
generating the threshold voltage; and
providing the threshold voltage to the comparator.

8. The method of claim 7, wherein the threshold voltage is generated by dividing the threshold voltage from a voltage applied to the charge circuit using at least one resistor.

9. The method of claim 6, wherein the monitoring of the current monitors the current flowing into the rechargeable battery when the voltage of the rechargeable battery is greater than or equal to the threshold voltage.
